(19) United States
(12) Patent Application Publication
(10) Pub. No.: US 2026/0309188 A1
(43) Pub. Date: Oct. 8, 2026

(54) ROLLING BEARING WITH ATTACHED RACEWAYS, IN PARTICULAR FOR A STEERING COLUMN

(71) Applicant: AKTIEBOLAGET SKF, GOTEBORG (SE)

(72) Inventors: Baptiste VIDIL, Levallois-Perret (FR); Thomas LEPINE, Tours (FR); Lucia KNOBLAUCH, Buchheim (DE); Bruno MONTBOEUF, Saint-Cyr-Sur-Loire (FR)

(21) Appl. No.: 19/577,676

(22) Filed: Mar. 25, 2026

(30) Foreign Application Priority Data
Apr. 3, 2025 (FR) FR2503494

(51) Int. Cl. F16C 25/08; B62D 1/16; F16C 33/58

(52) U.S. Cl. CPC F16C 25/083; B62D 1/16; F16C 33/585; F16C 2202/04; F16C 2202/06; F16C 2326/24

(57) ABSTRACT

A rolling bearing for a steering column includes a first ring and a second ring mounted coaxially with the first ring and a row of balls between the rings. The second ring is a casing having an axial portion and first and second radial portions extending from ends thereof. A cup is arranged in the casing, and a surface of the cup forms a first raceway for balls. A prestressing element is mounted axially between the cup and the second radial portion of the casing and exerts an axial force on the cup. The casing includes an extension extending obliquely from the first radial portion toward the axial portion, and a surface of the extension forms a second raceway for the balls, and the second radial portion extends obliquely towards an inside of the casing.

### CROSS-REFERENCE

This application claims priority to French patent application no. FR2503494 filed on Apr. 3, 2025, the contents of which are fully incorporated herein by reference.

### TECHNOLOGICAL FIELD

The present disclosure relates to the field of rolling bearings and in particular to rolling bearings used in motor vehicle steering columns.

### BACKGROUND

Steering columns generally comprise a shaft, one end of which is secured to a steering wheel which allows a driver to turn the steering column and the other end of which is secured to mechanical components the role of which is to perform the angular positioning of the wheels of the vehicle. The shaft of the steering column is rotatably mounted in a tubular housing via two rolling bearings.

One type of rolling bearing for a steering column comprises an inner ring, an outer ring and a row of balls arranged between raceways of the rings. At least one of the rings comprises a casing and attached elements arranged in the casing to form raceways of the ring. The attached elements are commonly in the form of two separate wires arranged axially on either side of the balls. Generally, such a bearing also comprises an elastic prestressing element mounted inside the casing and bearing axially against one of the attached elements.

The architecture of such a rolling bearing makes it possible to avoid the presence of internal play inside the bearing but does not completely limit the axial and radial movements between the rings, even by adjusting the preload of the bearing after assembly.

In addition, soundproofing requirements are increasingly high with the development of electric and hybrid vehicles, offering rolling bearings room for improvement in this area.

### SUMMARY

One aspect of the disclosure is a rolling bearing, in particular for a steering column, comprising a first ring, a second ring and at least one row of balls arranged between the rings, the second ring comprising a casing having an axial portion, a first radial portion extending from a first end of the axial portion and a second radial portion extending from a second end of the axial portion, a cup arranged in the casing and delimiting a first raceway for the row of balls, and at least one prestressing element mounted axially between the cup and the second radial portion of the casing and exerting an axial force on the cup.

The casing of the second ring comprises an extension which obliquely extends from the first radial portion in the direction of the axial portion and which delimits a second raceway for the row of balls. The second radial portion of the casing extends obliquely towards the inside of the casing. Thus, the rolling bearing will allow less axial deflection with equivalent prestress without compromising the friction torque. This also makes it possible to increase the axial rigidity of the bearing.

Advantageously, the first ring comprises first and second end faces delimiting the axial length of the first ring, the casing of the second ring remaining axially set back from the first and second end faces. This arrangement makes it possible to reduce unwanted friction between the second ring and other elements of the steering column after assembly.

According to one embodiment, the first ring comprises a cylindrical outer surface and a cylindrical inner surface delimiting the radial thickness of the first ring, one of the outer and inner surfaces being provided with a raceway for the row of balls. Advantageously, the casing is produced in one piece. This makes it possible to improve the rigidity and fluidity of the bearing and to simplify the design and manufacture thereof.

In one embodiment, the casing is formed from a steel having a hardness of between 200 and 500 HB, and whose yield strength is between 500 and 1200 MPa. Preferably, the extension of the casing of the second ring remains at a distance from the axial portion. Advantageously, the cup of the second ring remains at a distance from the axial portion of the casing. Again advantageously, the first raceway of the cup is concave and the second raceway of the extension of the casing is flat.

In another embodiment, the first raceway of the cup is flat and the second raceway of the extension is concave. In yet another embodiment, the first raceway and the second raceway are flat. Finally, in yet another embodiment, the first raceway and the second raceway are concave.

Advantageously, the first ring is the inner ring of the rolling bearing and the second ring is the outer ring of the rolling bearing. Alternatively, it is possible to provide an inverted arrangement.

A further subject of the disclosure is a steering column comprising a housing, a shaft coaxial with the housing and at least one rolling bearing as defined above, mounted radially between the housing and the shaft.

### BRIEF DESCRIPTION OF THE DRAWINGS

Other aims, features and advantages of the disclosure will become apparent upon reading the following description, which is given purely by way of non-limiting example and with reference to the appended drawings, in which:

FIG. 1 is an axial sectional view of a rolling bearing according to an exemplary embodiment of the present disclosure.

FIG. 2 is a detail view of a portion of FIG. 1.

### DETAILED DESCRIPTION

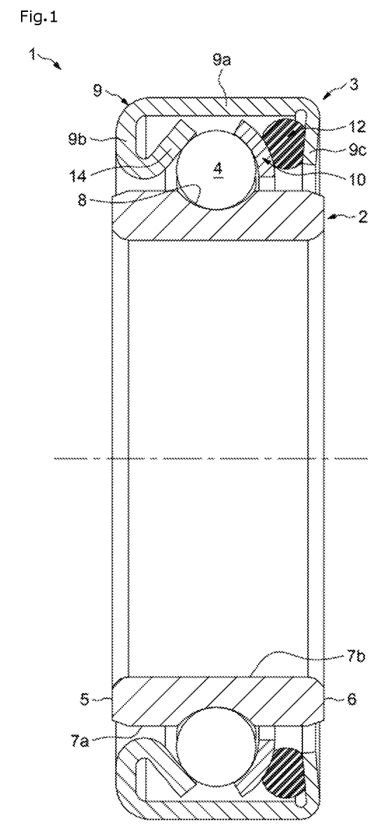

FIG. 1 illustrates a rolling bearing designated by the reference numeral 1, comprising a first ring 2, a second ring 3, and a row of balls 4 arranged between the first and second rings 2, 3. In this embodiment, the first ring 2 is the inner ring of the rolling bearing 1 and the second ring 3 is the outer ring of the rolling bearing 1.

The inner ring 2 comprises a cylindrical bore delimited axially by first and second opposite end faces 5, 6 delimiting the axially length of the inner ring 2. The inner ring 2 further comprises a cylindrical outer surface 7a and a cylindrical inner surface 7b forming a bore delimiting the radial thickness of the inner ring 2.

A toroidal circular groove is formed in the cylindrical outer surface 7a of the inner ring 2 and has, in cross section, a concave inner profile capable of forming a raceway 8 for the balls 4, the groove being oriented radially outwards. Advantageously, the inner ring 2 is solid. A “solid ring” is understood to mean a ring having a shape obtained by machining with stock removal (turning or grinding) from tubes, bars, or forged and/or rolled blanks.

The outer ring 3 comprises an outer casing 9 of annular shape, having an axial (axially extending) portion 9a, a first radial portion 9b extending from a first end of the axial portion 9a and a second radial portion 9c extending from a second end of the axial portion 9a. As will be described in greater detail below, the casing 9 also comprises an extension 14 which extends from an end of the first radial portion 9c.

In the embodiment illustrated in the figures, the casing 9 remains axially set back from the first and second end faces 5, 6 of the inner ring 2. Also, maximum axial width of the casing 9 is less than the maximum axial spacing between the first and second end faces 5, 6 of the inner ring 2.

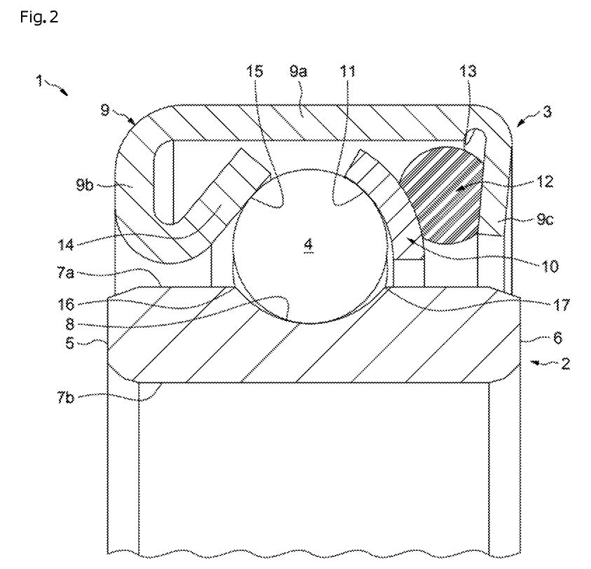

As illustrated in FIG. 2, the outer ring 3 further comprises an annular cup 10 arranged in the casing 9 making it possible to delimit a first raceway 11 for the balls 4. The raceway 11 has a concave shape. The cup 10 is mounted axially between the balls 4 and the second radial portion 9c of the casing 9. The cup 10 remains radially at a distance from the axial portion 9a of the casing 9. The cup 10 has a concave shape oriented towards the balls 4. The cup 10 has a constant thickness. The cup 10 is made of a rigid material, for example steel.

The outer ring 3 also comprises a prestressing element 12 mounted axially between the cup 10 and the second radial portion 9c of the casing 9, making it possible to exert an axial force on the cup 10.

As illustrated in the figures, the casing 9 also has a reduction in material 13 at the corner between the axial portion 9a and the second radial portion 9c. The reduced thickness of the second radial portion 9c makes it easier to curve it in the direction of the balls 4 so as to bear against the prestressing element 12 and axially prestress the bearing 1. Specifically, the second radial portion 9c of the casing 9 extends obliquely towards the inside of the casing 9, making it possible to increase the axial force exerted on the cup 10 by exerting an axial force on the prestressing element 12.

The annular prestressing element 12 is mounted axially in contact against the radial portion 9c of the casing 9, and the cup 10 is mounted radially between the axial portion 9a of the casing 9 and the cylindrical outer surface 7a of the inner ring 2, while remaining spaced from them. A radial surface of the prestressing element 12 is in axial contact with the inner face of the radial portion 9c and an opposite radial surface is in axial contact with the cup 10. The prestressing element 12 remains at a distance from the balls 4. The prestressing element 12 exerts a continuous axial force on the cup 10 which tends to prestress the balls 4 on the extension 14 of the casing 9 of the outer ring 3 and on the raceway 8 of the inner ring 2.

The prestressing element 12 is advantageously formed from an elastic material, for example an elastomer such as nitrile rubber or polyurethane. In the embodiment illustrated, the prestressing element 12 is in the form of a torus of circular cross section. The advantage of a prestressing element of circular cross section is to allow the respective centering of the raceways, and also to prevent any relief regions during rotation that could disturb the correct rotation of the rolling bearing. As a variant, it could be possible to provide a prestressing element 12 having, in cross section, another profile, for example a square profile.

As indicated above, the casing 9 comprises an extension 14 which extends obliquely from the first radial portion 9c in the direction of the axial portion 9a of the casing 9. The extension 14 extends from the end of the first radial portion 9c which is radially on the opposite side to the axial portion 9a. The extension 14 extends towards the inside of the bearing 1. The extension 14 is located axially between the balls 4 and the first radial portion 9b of the casing 9 and makes it possible to delimit a second raceway 15 for the balls 4. The raceway 15 (formed on an end of the extension 14) has a flat shape. The extension 14 remains radially at a distance from the axial portion 9a.

The casing 9 is produced in one piece. Advantageously, it can be manufactured by cutting and pressing a metal sheet. Advantageously, the casing 9 is formed from a steel having a hardness of between 200 and 500 HB, and more particularly between 300 and 350 HB. Moreover, it is preferable to provide a steel whose yield strength is between 500 and 1200 MPa, and more particularly between 800 and 900 MPa. The casing 9 is thus formed of a steel ensuring a compromise between good durability of the raceway for the rolling elements and good feasibility of the manufacturing methods, such as stamping and bending. For example, the steel for the casing 9 may comprise HLE 850.

The balls 4 are arranged between the cup 10 and the extension 14 of the outer ring 3 which form the raceways 11, 15, and the raceway 8 of the inner ring 2. A rolling bearing 1 with three contact points is thus produced.

As illustrated more visibly in FIG. 2, the raceway 8 of the inner ring 2 has a first axial end 16 and a second axial end 17 which delimit the axial length of the raceway 8. The first and second axial ends 16, 17 are connected to the cylindrical outer surface 7a of the inner ring 2. The first and second axial ends 16, 17 are also aligned considering the radial direction.

As indicated above, in the exemplary embodiment illustrated, the first ring 2 of the bearing is the inner ring and the second ring 3 is the outer ring. Alternatively, it is possible to provide an inverted arrangement of the bearing 1 in which the first ring 2 is the outer ring and the second ring 3 is the inner ring. In this case, the circular groove of the first ring 2 is formed from the cylindrical inner surface 7b of the first ring 2.

Advantageously, the rolling bearing of the disclosure makes it possible to maximize the prestress on the raceways and the rolling elements, and thus its rigidity. Furthermore, in another embodiment, the rolling bearing 1 may comprise a cage arranged radially between the rings 2, 3 to maintain a regular circumferential spacing between the balls 4.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rolling bearings such as those intended for use in a steering column of an automobile.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A rolling bearing for a steering column, comprising:
a first ring,
a second ring mounted coaxially with the first ring and comprising a casing having an axial portion, a first radial portion extending from a first axial end of the axial portion and a second radial portion extending from a second axial end of the axial portion,
a row of balls between the first ring and the second ring,
a cup arranged in the casing, a surface of the cup forming a first raceway for the row of balls, and
prestressing means mounted axially between the cup and the second radial portion of the casing for exerting an axial force on the cup,
wherein the casing includes an extension extending obliquely from the first radial portion toward the axial portion, a surface of the extension forming a second raceway for the row of balls, and
wherein the second radial portion of the casing extends obliquely towards an inside of the casing.

2. The rolling bearing according to claim 1,
wherein the prestressing means comprises an elastomeric ring.

3. The rolling bearing according to claim 2,
wherein the elastomeric ring is an O-ring formed of nitrile rubber or polyurethane.

4. The bearing according to claim 2, wherein the casing is formed as one piece.

5. The bearing according to claim 2,
wherein the casing is formed from a steel having a hardness between 200 and 500 HB and a yield strength between 500 and 1200 MPa.

6. The bearing according to claim 5,
wherein the cup does not contact the axial portion of the casing.

7. The bearing according to claim 1,
wherein the first raceway is concave and toroidal and the second raceway is conical.

8. The bearing according to claim 1,
the first ring is an inner ring of the rolling bearing, and the second ring is an outer ring of the rolling bearing.

9. The bearing according to claim 1,
wherein the first ring has first and second end faces delimiting an axial length of the first ring, and
wherein the casing remaining axially set back from the first and second end faces.

10. The bearing according to claim 1,
wherein the first ring comprises a cylindrical outer surface and a cylindrical inner surface delimiting a radial thickness of the first ring, and
wherein the outer surface or the inner surface includes a third raceway for the row of balls.

11. The bearing according to claim 1,
wherein the extension is spaced from the axial portion.

12. The rolling bearing according to claim 2,
wherein the first ring is an inner ring and includes a third raceway for the row of rolling elements,
wherein the casing is formed as one piece from a steel having a hardness between 200 and 500 HB and a yield strength between 500 and 1200 MPa,
wherein the cup does not contact the axial portion of the casing,
wherein the first raceway is concave and toroidal and the second raceway is conical, and
wherein the extension is spaced from the axial portion.

13. A steering column comprising:
a housing,
a shaft coaxial with the housing, and
a rolling bearing according to claim 12 mounted radially between the housing and the shaft.

14. A steering column comprising:
a housing,
a shaft coaxial with the housing, and
a rolling bearing according to claim 1 mounted radially between the housing and the shaft.
